(19) United States
(12) Patent Application Publication
(10) Pub. No.: US 2026/0085883 A1
(43) Pub. Date: Mar. 26, 2026

(54) HEAT INTEGRATION FOR HEATING LIQUID AND TWO-PHASE HYDROCARBON STREAMS

(71) Applicant: UOP LLC, Des Plaines, IL (US)

(72) Inventors: Chintan Surendra Shah, Ahmedabad (IN); Amit Munjal, Haryana (IN); Donald A. Eizenga, Eik Grove Village, IL (US)

(21) Appl. No.: 19/219,387

(22) Filed: May 27, 2025

Related U.S. Application Data
(60) Provisional application No. 63/697,727, filed on Sep. 23, 2024.

(51) Int. Cl. F25J 3/02

(52) U.S. Cl. CPC F25J 3/02; F25J 2200/74; F25J 2205/04

(57) ABSTRACT

Processes for preheating a feed stream to a second column are described. The processes integrate electric heaters or other heating sources with all-liquid or two phase fired heaters, or electric heaters or furnaces, or combinations thereof and shift a portion of the fired heater, or electric heater or furnace, or combinations thereof duty to an electric heater or other heat source. The feed stream, which can be from a flash drum or a stream from a first column, may be preheated before being heated in the fired heater. The process involves heating or superheating a vapor stream downstream of a two phase separator to a targeted temperature to provide a sufficient temperature that the heated/superheated vapor stream acts as a heat source to a targeted service.

### RELATED APPLICATIONS

This application claims priority to U.S. Provisional Patent Application Ser. No. 63/697,727 filed on Sep. 23, 2024, the entirety of which is incorporated herein by reference.

### BACKGROUND

The worldwide concern over global warming and the goal of various countries to reduce their CO₂ footprint and/or to become carbon neutral is challenging industries to come up with cleaner, more environmentally friendly processes. One way to make an overall process involving hydrocarbon streams more environmentally friendly is to maximize usage of green electricity for heating purposes. However, electric heating is not widely used to heat liquid hydrocarbon and two phase (liquid hydrocarbon and vapor hydrocarbon) streams currently due to the potential for coking, thermal cracking, and/or fouling by the liquid hydrocarbon. Instead, fired heaters are used to achieve process unit objectives for fractionation including, but not limited to, bottom reboiling, column side draw heating/reboiling, column feed preheating, two phase heaters, and the like. The fired heaters are used in a variety of technologies, including but not limited to hydrotreating naphtha, diesel, kerosene, and like, reforming, isomerization, hydroprocessing, hydrocracking, low sulfur processing, production of renewable diesel and jet fuel, dehydrogenation processes, xylene fractionation, aromatics separation processes, transalkylation, oligomerization and the like.

Therefore, there is need for hydrocarbon processes which have a reduced CO₂ footprint.

### BRIEF DESCRIPTION OF THE DRAWINGS

FIG. 1 is an illustration of one embodiment of a process involving the integration of a reboiler fired heater and a heater.

FIG. 2 is an illustration of another embodiment of a process involving the integration of a reboiler fired heater and a heater.

FIG. 3 is an illustration of still another embodiment of a process involving the integration of a reboiler fired heater and a heater.

### DESCRIPTION

The present invention relates to processes involving the heating of liquid and two phase (liquid hydrocarbon and vapor hydrocarbon) hydrocarbon streams. The processes integrate electric heaters or other heating sources such as steam and/or hot water, hot oil, another hotter hydrocarbon stream (vapor, liquid, or two phase), and like, with any all-liquid or two phase fired heaters, electric heaters or furnaces, or combinations thereof. The heat integration scheme provides a reduction in CO₂ emissions and makes the overall process greener. The processes permit the integration of electric heaters in reboiler or two phase services without the concerns of coking, thermal cracking, and/or fouling by the liquid hydrocarbon. It also results in reduced fuel consumption, and reduced size of the fired heater, leading to plot space savings. This process can be applied to any heater which has two phases at the fired heater outlet.

The process shifts a portion of the fired heater, or electric heater or furnace, or combinations thereof duty to an electric heater or other heat source. There can be one or more electric heaters (or other heater source as described above) in series and/or in parallel to achieve the desired heating. All or a portion of a vapor stream from a two phase separator is heated by an electric heater or other heater source (or multiple electric heaters or other sources in series and/or in parallel) to a requisite temperature which may vary among different processes and the desired objectives. For example, the requisite temperature for a reboiling stream will be the temperature required to achieve a targeted percentage of vapor to facilitate fractionation column operation. If the heat integration is in column feed, then the temperature can be the desired temperature to achieve particular technology's stream properties feeding to the column. Suitable temperatures are be determined by those of skill in the art based on the particular process, and the streams involved. The heated vapor stream exchanges heat with an incoming liquid hydrocarbon stream from a column (a column bottom stream, a column side draw stream, or both), increasing the fired heater inlet temperature and resulting in a reduction in the fired heater duty.

The process involves heating or superheating a vapor stream downstream of a two phase separator to a targeted temperature to provide a sufficient temperature that the heated/superheated vapor stream acts as a heat source to a targeted service where this was not possible previously because the outlet temperature of the fired heater, or electric heater or furnace, or combinations thereof was constrained by the operating temperature and pressure of the downstream equipment, which can be a column, a reactor, and the like.

By incorporating the heat integration, the fired heater, or electric heater or furnace, or combinations thereof duty and the size of the fired heater, or electric heater or furnace, or combinations thereof are reduced, resulting in a reduction in the fuel consumption and CO₂ emissions of the process. Furthermore, the footprint of the fired heaters, or electric heaters or furnaces, or combinations thereof is reduced, leading to capital cost reductions, as well as reduced pressure drop across the fired heaters, or electric heaters or furnaces, or combinations thereof due to the reduction of the individual duties. This will help to offset the pressure drop due to the additional equipment in form of heat exchangers (other heaters) and electric heaters. If the customer is switching to 100% hydrogen fuel, the integration and reduced fired heater duty gives customer flexibility to consume lesser hydrogen as fuel, which in turn reduces operating expenses and facilitates achieving the net zero goal.

The heat integration scheme paves way to heat integrate multiple heater services and to transition to a green electricity based heating scheme. Incorporating multiple heater services offers even greater benefits than replacing charge heaters with electric heaters, while offering low capital and operating costs.

The feed stream to a second column, which can be a stream from a flash drum or a stream from a first column, is sent to a heat exchanger where it exchanges heat with a vapor stream, increasing the temperature of the feed stream. The preheated feed stream can be only liquid or liquid and vapor, depending on the particular process and streams involved. The preheated feed stream is sent to the fired heater, or electric heater or furnace, or combinations thereof for further heating and/or phase change (reboiling). The fired heater, or electric heater or furnace, or combinations thereof duty is reduced because of the preheating of the feed stream in the heat exchanger. The heated feed stream downstream of the fired heater, or electric heater or furnace, or combinations thereof is separated in a two phase separator into a vapor stream and a liquid stream.

In some embodiments, the vapor stream used in the heat exchanger is heated before being sent to the heat exchanger to preheat the feed stream.

The cooled stream from the heat exchanger is combined with the liquid stream from the two phase separator and sent as the feed stream to the second column.

The vapor stream from the two phase separator can be split into multiple streams (two or more) downstream of two phase separator. The vapor stream can be heated/superheated with an electric heater (or other heat source) before or after the vapor stream is split. One or more of the vapor streams split from the vapor stream from the two phase separator can be heated/superheated with an electric heater (or other heat source).

There can be valve on one of the vapor streams from the two phase separator. In some embodiments, the valve will be normally closed so that the entire vapor stream flows to the electric heater (or other heat source).

The stream split from the vapor stream can be heated/superheated by electric heater (or other heat source), and all or a portion of the heated/superheated stream can act as a heat source for one or more other process streams in same process unit or any other process unit. One or more electric heaters (or other heat source) can be used to heat the vapor stream. For example, the vapor stream can be heated/superheated by an electric heater, the heated/superheated vapor stream can be used as a heat source for one or more process streams, then it can be heated/superheated again, and used as a heat source for one or more additional process streams. Alternatively, the vapor stream can be heated/superheated by an electric heater, and the heated/superheated vapor stream can be used as a heat source for two or more process streams. The cooled vapor stream can then be heated/superheated by another electric heater.

The cooled vapor stream can be combined with a portion of the vapor stream from the two phase separator and used as the vapor stream to heat exchange with the feed stream to the column.

The process streams which are heated using the heated/superheated vapor stream from the first fired heater, or electric heater or furnace, or combinations thereof can be sent to a second fired heater, leading to the reduced fired duty for the second fired heater. The same situation applies in the arrangement discussed below.

The heat integration can be incorporated into any hydrocarbon process including a feed stream for a column and a fired heater. Suitable hydrocarbon processes include, but are not limited to, hydrotreating, reforming, isomerization, hydroprocessing, hydrocracking, low sulfur processing, production of renewable diesel and jet fuel, dehydrogenation processes, xylene fractionation, aromatics separation processes, transalkylation, oligomerization, and the like.

In another arrangement, the feed stream for the column flows to the fired heater, or electric heater or furnace, or combinations thereof without being sent through a heat exchanger. The heated feed stream is separated in the two phase separator into a vapor stream and a liquid stream. The vapor stream is heated/superheated with an electric heater or other heat source. The heated/superheated vapor stream acts as a heat source for a process stream resulting in a cooled vapor stream and a heated process stream. The cooled vapor stream can be heated/superheated again and used as a heat source for a second process stream. The second cooled vapor stream can be mixed with the bottom liquid stream from the two phase separator and sent to the column as the feed stream. Suitable process streams include, but are not limited to, reboiler streams, column feed streams, reactor feed streams and the like.

Electric heaters or furnaces include, but are not limited to, immersion heaters, impedance heaters, hot oil/utility heating (with electric heat supplied to the utility), and radiant electric heaters.

For ease of discussion, the flow schemes are focused on a fired heater and the feed stream for a column, but the heat integration can be applied for any two phase fired heater. For ease of discussion below, the term “fired heater, or electric heater or furnace, or combinations thereof” will be replaced by “fired heater.” Further, the electric heaters downstream of the “fired heater, or electric heater or furnace, or combinations thereof” could be replaced by any of the other heat sources, as discussed above.

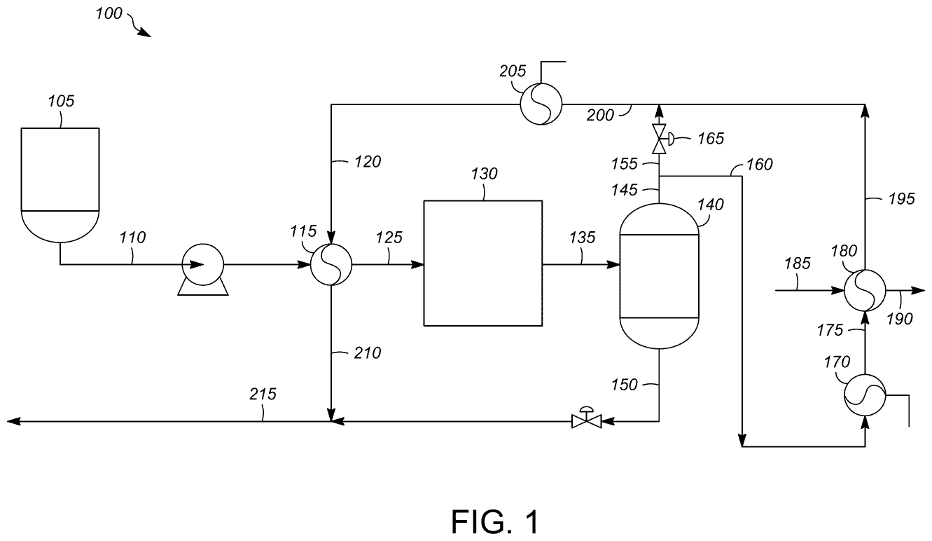

FIG. 1 illustrates the integration of a fired heater and an electric heater. In the process 100, a feed stream 110 from a flash drum or a first column 105 comprises a liquid stream.

The feed stream 110 is sent to a heat exchanger 115 where it is preheated by heated vapor stream 120. The preheated stream 125 is sent to a fired heater 130 where it is further heated.

The heated stream 135, which is a mixture of liquid and vapor, is sent to a two phase separator 140 where it is separated into vapor stream 145 and liquid stream 150.

The vapor stream 145 from the two phase separator 140 is split into vapor streams 155, 160. There can be a valve 165 on the line for vapor stream 155, which can be open to allow vapor stream 155 flow though or closed to send all of the vapor to vapor stream 160.

The vapor stream 160 is heated/superheated in electric heater 170 (or other heat source, such as a utility or hydrocarbon stream) forming heated vapor stream 175. The heated vapor stream is heat exchanged in heat exchanger 180 with a process stream 185 forming heated process stream 190 and cooled vapor stream 195.

The cooled vapor stream 195 can be combined with vapor stream 155 from the two phase separator 140 (if valve 165 is open), and the combined stream 200 can be further heated in electric heater 205 forming heated vapor stream 120. The heated vapor stream 120 is heat exchanged with feed stream 110 from the flash drum or the first column 105 in heat exchanger 115 forming cooled vapor stream 210 (the cooled vapor stream 210 can be a mixture of liquid and vapor or completely vapor).

The liquid stream 150 from the two phase separator 140 is combined with the cooled vapor stream 210 from the heat exchanger 115 forming a combined mixed stream 215. The combined mixed stream 215 is sent as the feed stream to the second column (not shown).

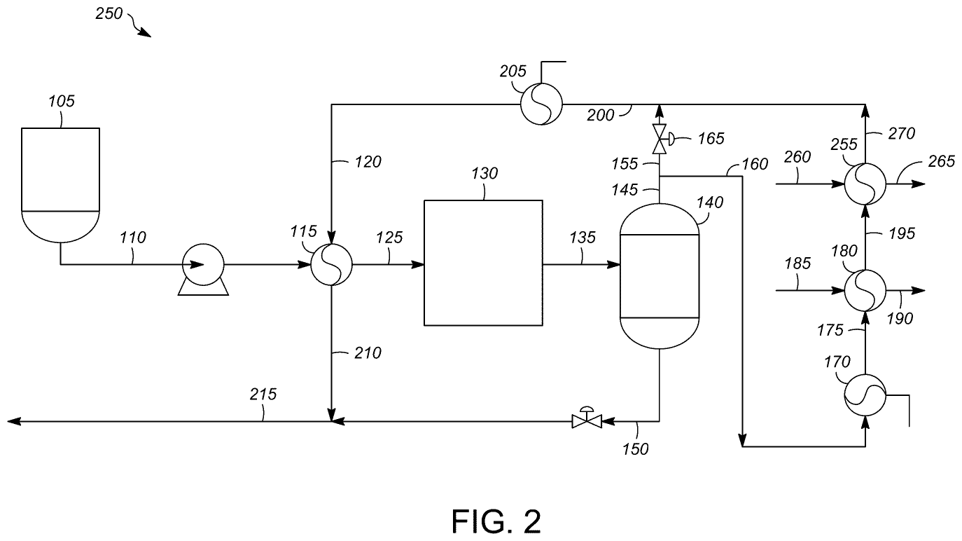

FIG. 2 illustrates a slightly different arrangement of the integration of the fired heater and the electric heater. In the process 250, the feed stream 110 from the flash drum or first column 105 comprises a liquid stream.

The feed stream 110 is sent to the heat exchanger 115 where it is preheated by heated vapor stream 120. The preheated stream 125 is sent to a fired heater 130 where it is further heated.

The heated stream 135, which is a mixture of liquid and vapor, is sent to a two phase separator 140 where it is separated into vapor stream 145 and liquid stream 150.

The vapor stream 145 from the two phase separator 140 is split into vapor streams 155, 160. There can be a valve 165 on the line for vapor stream 155, which can be open to allow vapor stream 155 flow though or closed to send all of the vapor to vapor stream 160. The valve 165 can be normally closed.

The vapor stream 160 is heated/superheated in electric heater 170 (or other heat source, such as a utility or hydrocarbon stream) forming heated vapor stream 175. The heated vapor stream 175 is heat exchanged in heat exchanger 180 with a process stream 185 forming heated process stream 190 and cooled vapor stream 195.

The cooled vapor stream 195 is sent to heat exchanger 255 where it is heat exchanged with process stream 260 resulting in heated process stream 265 and cooled vapor stream 270.

The cooled vapor stream 270 can be combined with vapor stream 155 from the two phase separator 140 (if valve 165 is open), and the combined stream 200 can be further heated in electric heater 205 forming heated vapor stream 120. The heated vapor stream 120 is heat exchanged with feed stream 110 from the flash drum or the first column 105 in heat exchanger 115 forming cooled vapor stream 210 (the cooled vapor stream 210 can be a mixture of liquid and vapor or completely vapor).

The liquid stream 150 from the two phase separator 140 is combined with the cooled vapor stream 210 from the heat exchanger 115 forming a combined mixed stream 215. The combined mixed stream 215 is sent as the feed stream to the second column (not shown).

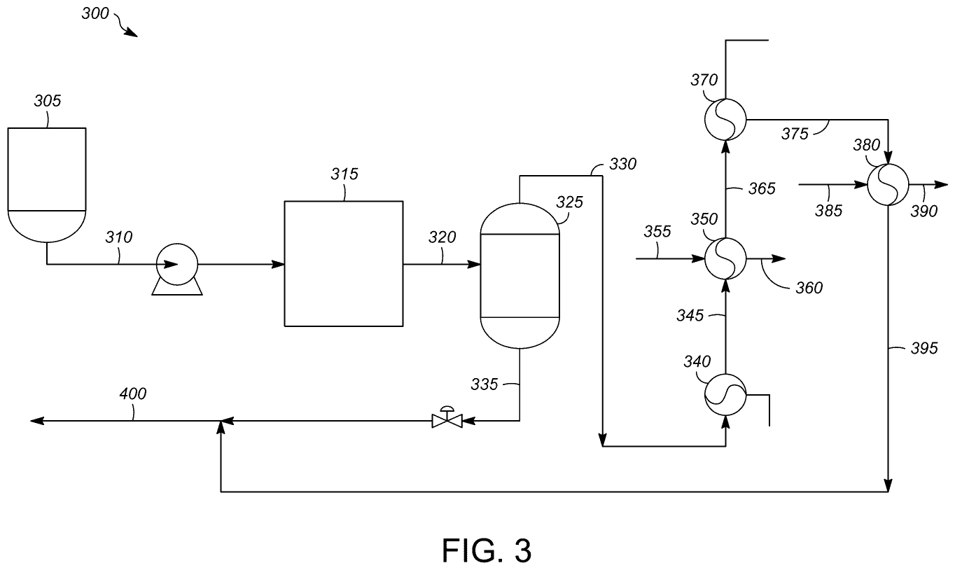

FIG. 3 illustrates another process 300 for the integration of the fired heater and the electric heater. In the process 300, the feed stream 310 from the flash drum or first column 305 comprises a liquid stream.

The feed stream 310 is sent to a fired heater 315 where it is heated.

The heated stream 320, which is a mixture of liquid and vapor, is sent to a two phase separator 325 where it is separated into vapor stream 330 and liquid stream 335.

The vapor stream 330 from the two phase separator 325 is heated/superheated in electric heater 340 (or other heat source, such as a utility or hydrocarbon stream) forming heated vapor stream 345. The heated vapor stream 345 is heat exchanged in heat exchanger 350 with a process stream 355 forming heated process stream 360 and cooled vapor stream 365.

The cooled vapor stream 365 is heated/superheated in a second electric heater 370 (or other heat source, such as a utility or hydrocarbon stream) forming heated vapor stream 375. The heated vapor stream 375 is heat exchanged in heat exchanger 380 with a process stream 385 forming heated process stream 390 and cooled vapor stream 395.

The cooled vapor stream 395 is combined with the liquid stream 335 from the two phase separator 325 forming a combined mixed stream 400. The combined mixed stream 400 is sent as the feed stream to the second column (not shown).

### Example

The fired heater duties for a process including a combined feed heater and a product fractionator heater (i.e., the second process stream) were modeled using process modeling software for a base case without heat integration and for one including heat integration according to the present invention. The results are shown in Table 1. The fired heater duties are reduced for both the combined feed heater and the product fractionator heater with the total reduction in fired heater duty being 27%.

TABLE 1
Summary of Fired Heater Duties

| | | Fired Heater Duties, | | | |
|---|---|---|---|---|---|
| | | MMBtu/h | | % Fired | |
| Sr. | | | With heat | duty | |
| No. | Service Name | Base | integration | reduction | Remarks |
| 1 | Combined Feed | 39 | 22 | 43.59 | High pressure |
| | Heater | | | | fired heater |
| | | | | | duty reduction |
| | | | | | can be offer |
| | | | | | CAPEX benefit |
| | | | | | in addition to |
| | | | | | reduction in |
| | | | | | carbon foot |
| | | | | | print |
| 2 | Product | 85 | 69 | 18.82 | |
| | Fractionator | | | | |
| | Feed Heater | | | | |
| | Total | 124 | 91 | 26.61 | Overall |
| | | | | | reduction in |
| | | | | | firing duty for |
| | | | | | both fired |
| | | | | | heaters |
| | | | | | combined |

A similar process modeling was done for a process including a combined feed heater and a product fractionator heater (i.e., the second process stream), and an SPK reboiler heater (i.e., a third process stream). The results are shown in Table 2. The fired heater duties are reduced for the combined feed heater and the product fractionator heater and the SPK reboiler heater is replaced with a heat exchanger resulting in a total reduction in fired heater duty of 24%.

TABLE 2
Summary of Fired Heater Duties with NO SPK Reboiler Heater

| | | Fired Heater Duties, | | | |
|---|---|---|---|---|---|
| | | MMBtu/h | | % Fired | |
| Sr. | | | With heat | duty | |
| No. | Service Name | Base | integration | reduction | Remarks |
| 1 | Combined | 39.00 | 22.00 | 43.59 | High pressure |
| | Feed Heater | | | | fired heater |
| | | | | | duty reduction |
| | | | | | can offer |
| | | | | | CAPEX benefit |
| | | | | | in addition to |
| | | | | | reduction in |
| | | | | | carbon foot |
| | | | | | print |
| 2 | Product | 85.00 | 82.35 | 3.12 | |
| | Fractionator | | | | |
| | Feed Heater | | | | |
| 3 | SPK Reboiler | 13.35 | 0.00 | 0.00 | This service |
| | Heater | | | | is no more a |
| | | | | | fired heater |
| | | | | | and instead is |
| | | | | | converted as |
| | | | | | an exchanger, |
| | | | | | so one major |
| | | | | | equipment |
| | | | | | count is |
| | | | | | reduced |
| | Total | 137.35 | 104.35 | 24.03 | Overall |
| | | | | | reduction in |
| | | | | | firing duty |
| | | | | | for all |
| | | | | | fired heaters |
| | | | | | combined |

Thus, the reduction in fired duty using the heat integration of the present invention is in the range of 20% to 40%.

### SPECIFIC EMBODIMENTS

While the following is described in conjunction with specific embodiments, it will be understood that this description is intended to illustrate and not limit the scope of the preceding description and the appended claims.

A first embodiment of the invention is a process for preheating a feed stream to a second column, the feed stream comprising a stream from a flash drum or a stream from a first column, comprising heat exchanging the feed stream with a vapor stream from a two phase separator in a first heat exchanger forming a preheated feed stream and a cooled vapor stream; heating the preheated feed stream in a fired heater, or an electric heater or furnace, or combinations thereof forming a heated feed stream comprising a mixture of liquid and vapor; separating the heated feed stream in a two phase separator into a vapor stream and a liquid stream; heating at least a first portion of the vapor stream forming a heated first portion of the vapor stream; heat exchanging the heated first portion of the vapor stream with a first process stream in a second heat exchanger forming a cooled first portion of the vapor stream and a heated process stream; heating the cooled first portion of the vapor stream forming a second heated first portion of the vapor stream, wherein heat exchanging the feed stream with the vapor stream comprises heat exchanging the feed stream with the second heated first portion of the vapor stream; combining the cooled vapor stream from the first heat exchanger and the liquid stream from the two phase separator forming a combined vapor and liquid stream; and introducing the combined vapor and liquid stream to the second column. An embodiment of the invention is one, any or all of prior embodiments in this paragraph up through the first embodiment in this paragraph wherein heating at least the first portion of the vapor stream comprises heating at least the first portion of the vapor stream using an electric heater or a second process stream; or wherein heating the cooled first portion of the vapor stream comprises heating the cooled first portion of the vapor stream using an electric heater or a third process stream; or both. An embodiment of the invention is one, any or all of prior embodiments in this paragraph up through the first embodiment in this paragraph wherein the second process stream or the third process stream or both comprises a reboiler stream, a column feed stream, a reactor feed stream, or combinations thereof. An embodiment of the invention is one, any or all of prior embodiments in this paragraph up through the first embodiment in this paragraph wherein the second process stream or the third process stream comprises a single phase or two phases. An embodiment of the invention is one, any or all of prior embodiments in this paragraph up through the first embodiment in this paragraph wherein the first portion of the vapor stream from the two phase separator comprises 100% of the vapor stream from the two phase separator. An embodiment of the invention is one, any or all of prior embodiments in this paragraph up through the first embodiment in this paragraph wherein the first portion of the vapor stream from the two phase separator comprises less than 100% of the vapor stream from the two phase separator, and further comprising dividing the vapor stream from the two phase separator into the first portion and a second portion; combining the second portion of the vapor stream from the two phase separator with the cooled first portion of the vapor stream forming a combined vapor stream; and wherein heating the cooled first portion of the vapor stream comprises heating the combined vapor stream. An embodiment of the invention is one, any or all of prior embodiments in this paragraph up through the first embodiment in this paragraph wherein the preheated feed stream comprises vapor, or liquid, or both. An embodiment of the invention is one, any or all of prior embodiments in this paragraph up through the first embodiment in this paragraph further comprising heat exchanging the cooled first portion of the vapor stream with a second process stream forming a second cooled first portion of the vapor stream and a second heated process stream; and wherein heating the cooled first portion of the vapor stream comprises heating the second cooled first portion of the vapor stream. An embodiment of the invention is one, any or all of prior embodiments in this paragraph up through the first embodiment in this paragraph wherein the first heat exchanger or the second heat exchanger or both comprise a shell and tube heat exchanger, a spiral tube heat exchanger, a vertical combined feed exchanger, a plate bundle heat exchanger, or combinations thereof. An embodiment of the invention is one, any or all of prior embodiments in this paragraph up through the first embodiment in this paragraph wherein the first process stream comprises a reboiler stream, a column feed stream, a reactor feed stream, or combinations thereof. An embodiment of the invention is one, any or all of prior embodiments in this paragraph up through the first embodiment in this paragraph wherein the first process stream comprises a single phase or two phases.

A second embodiment of the invention is an apparatus comprising a flash drum or a first column having an inlet and an outlet; a first heat exchanger having a first inlet, a first outlet, a second inlet, and a second outlet, the first inlet being in downstream fluid communication with the outlet of the flash drum or the first column; a fired heater, or an electric heater or furnace, or combinations thereof having an inlet and an outlet, the inlet of the fired heater, or the electric heater or furnace, or combinations thereof being in downstream fluid communication with the first outlet of the first heat exchanger; a two phase separator having an inlet, a vapor outlet, and a liquid outlet, the inlet of the two phase separator being in downstream fluid communication with the outlet of the fired heater, or the electric heater or electric furnace, or combinations thereof; a second heat exchanger having a first inlet, a first outlet, a second inlet, and a second outlet, the first inlet of the second heat exchanger being in downstream fluid communication with the vapor outlet of two phase separator, the second inlet of the second heat exchanger being in downstream fluid communication with a source of a process stream; the second inlet of the first heat exchanger being in downstream fluid communication with the first outlet of the second heat exchanger; a manifold having a first inlet, a second inlet, and an outlet, the first inlet of the manifold being in downstream fluid communication with the second outlet of the first heat exchanger, the second inlet of the manifold being in downstream fluid communication with the liquid outlet of the two phase separator; and a second column having an inlet and an outlet, the inlet of the second column being in downstream fluid communication with the outlet of the manifold; a first heater or heat source in thermal communication with a line between the vapor outlet of the two phase separator and the first inlet of the second heat exchanger; a second heater or heat source in thermal communication with a line between the first outlet of second heat exchanger and the second inlet of the first heat exchanger. An embodiment of the invention is one, any or all of prior embodiments in this paragraph up through the second embodiment in this paragraph wherein the second inlet of the first heat exchanger is in selective downstream communication with the vapor outlet of the two phase separator. An embodiment of the invention is one, any or all of prior embodiments in this paragraph up through the second embodiment in this paragraph wherein the first heat exchanger or the second heat exchanger or both comprises a shell and tube heat exchanger, a spiral tube heat exchanger, a vertical combined feed exchanger, a plate bundle heat exchanger, or combinations thereof.

A third embodiment of the invention is a process for preheating a feed stream to a second column, the feed stream comprising a stream from a flash drum or a stream from a first column, comprising heating the feed stream in a fired heater, or an electric heater or furnace, or combinations thereof forming a heated feed stream comprising a mixture of liquid and vapor; separating the heated feed stream in a two phase separator into a vapor stream and a liquid stream; heating the vapor stream forming a heated vapor stream; heat exchanging the heated vapor stream with a first process stream in a first heat exchanger forming a cooled vapor stream and a heated process stream; combining the cooled vapor stream from the heat exchanger and the liquid stream from the two phase separator forming a combined vapor and liquid stream; and introducing the combined vapor and liquid stream to the second column. An embodiment of the invention is one, any or all of prior embodiments in this paragraph up through the third embodiment in this paragraph heating the cooled vapor stream forming a second heated vapor stream; heat exchanging the second heated vapor stream in a second heat exchanger with a second process stream forming a second cooled vapor stream and a second heated process stream; and wherein combining the cooled vapor stream from the heat exchanger and the liquid stream from the two phase separator comprises combining the second cooled vapor stream from the heat exchanger and the liquid stream from the two phase separator. An embodiment of the invention is one, any or all of prior embodiments in this paragraph up through the third embodiment in this paragraph wherein the second process stream comprises a reboiler stream, a column feed stream, a reactor feed stream, or combinations thereof. An embodiment of the invention is one, any or all of prior embodiments in this paragraph up through the third embodiment in this paragraph wherein the second process stream comprises a single phase or two phases. An embodiment of the invention is one, any or all of prior embodiments in this paragraph up through the third embodiment in this paragraph wherein heating the vapor stream forming a heated vapor stream comprises heating the vapor stream using an electric heater or a second process stream; or wherein heating the cooled vapor stream comprises heating the cooled vapor stream using an electric heater or a third process stream; or both. An embodiment of the invention is one, any or all of prior embodiments in this paragraph up through the third embodiment in this paragraph wherein the second process stream or the third process stream or both comprises a reboiler stream, a column feed stream, a reactor feedstream, or combinations thereof. An embodiment of the invention is one, any or all of prior embodiments in this paragraph up through the third embodiment in this paragraph wherein the second process stream or the third process stream comprises a single phase or two phases. An embodiment of the invention is one, any or all of prior embodiments in this paragraph up through the third embodiment in this paragraph wherein the first heat exchanger or the second heat exchanger or both comprise a shell and tube heat exchanger, a spiral tube heat exchanger, a vertical combined feed exchanger, a plate bundle heat exchanger, or combinations thereof.

A fourth embodiment of the invention is an apparatus comprising a flash drum or a first column having an inlet and an outlet; a fired heater, or an electric heater or furnace, or combinations thereof having an inlet and an outlet, the inlet of the fired heater, or the electric heater or furnace, or combinations thereof being in downstream fluid communication with the outlet of the flash drum or the first column; a two phase separator having an inlet, a vapor outlet, and a liquid outlet, the inlet of the two phase separator being in downstream fluid communication with the outlet of the fired heater, or the electric heater or furnace, or combinations thereof; a first heat exchanger having a first inlet, a first outlet, a second inlet, and a second outlet, the first inlet of the first heat exchanger being in downstream fluid communication with the vapor outlet of two phase separator, the second inlet of the first heat exchanger being in downstream fluid communication with a source of a process stream; a second heat exchanger having a first inlet, a first outlet, a second inlet, and a second outlet, the first inlet of the second heat exchanger being in downstream fluid communication with the first outlet of the first heat exchanger; a manifold having a first inlet, a second inlet, and an outlet, the first inlet of the manifold being in downstream fluid communication with the first outlet of the second heat exchanger, the second inlet of the manifold being in downstream fluid communication with the liquid outlet of the two phase separator; a second column having an inlet and an outlet, the inlet of the second column being in downstream fluid communication with the outlet of the manifold; a first heater or heat source in thermal communication with a line between the vapor outlet of two phase separator and the first inlet of the first heat exchanger; a second heater or heat source in thermal communication with a line between the first outlet of first heat exchanger and the first inlet of the second heat exchanger. An embodiment of the invention is one, any or all of prior embodiments in this paragraph up through the fourth embodiment in this paragraph wherein the first heat exchanger or the second heat exchanger or both comprise a shell and tube heat exchanger, a spiral tube heat exchanger, a vertical combined feed exchanger, a plate bundle heat exchanger, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for preheating a feed stream to a second column, the feed stream comprising a stream from a flash drum or a stream from a first column, comprising:
heat exchanging the feed stream with a vapor stream from a two phase separator in a first heat exchanger forming a preheated feed stream and a cooled vapor stream;
heating the preheated feed stream in a fired heater, or an electric heater or furnace, or combinations thereof forming a heated feed stream comprising a mixture of liquid and vapor;
separating the heated feed stream in a two phase separator into a vapor stream and a liquid stream;
heating at least a first portion of the vapor stream forming a heated first portion of the vapor stream;
heat exchanging the heated first portion of the vapor stream with a first process stream in a second heat exchanger forming a cooled first portion of the vapor stream and a heated process stream;
heating the cooled first portion of the vapor stream forming a second heated first portion of the vapor stream, wherein heat exchanging the feed stream with the vapor stream comprises heat exchanging the feed stream with the second heated first portion of the vapor stream;
combining the cooled vapor stream from the first heat exchanger and the liquid stream from the two phase separator forming a combined vapor and liquid stream; and
introducing the combined vapor and liquid stream to the second column.

2. The process of claim 1:
wherein heating at least the first portion of the vapor stream comprises heating at least the first portion of the vapor stream using an electric heater or a second process stream; or
wherein heating the cooled first portion of the vapor stream comprises heating the cooled first portion of the vapor stream using an electric heater or a third process stream;
or both.

3. The process of claim 2 wherein the second process stream or the third process stream or both comprises a reboiler stream, a column feed stream, a reactor feed stream, or combinations thereof.

4. The process of claim 2 wherein the second process stream or the third process stream comprises a single phase or two phases.

5. The process of claim 1 wherein the first portion of the vapor stream from the two phase separator comprises 100% of the vapor stream from the two phase separator.

6. The process of claim 1 wherein the first portion of the vapor stream from the two phase separator comprises less than 100% of the vapor stream from the two phase separator, and further comprising:
dividing the vapor stream from the two phase separator into the first portion and a second portion;
combining the second portion of the vapor stream from the two phase separator with the cooled first portion of the vapor stream forming a combined vapor stream; and
wherein heating the cooled first portion of the vapor stream comprises heating the combined vapor stream.

7. The process of claim 1 wherein the preheated feed stream comprises vapor, or liquid, or both.

8. The process of claim 1 further comprising:
heat exchanging the cooled first portion of the vapor stream with a second process stream forming a second cooled first portion of the vapor stream and a second heated process stream; and
wherein heating the cooled first portion of the vapor stream comprises heating the second cooled first portion of the vapor stream.

9. The process of claim 1 wherein the first heat exchanger or the second heat exchanger or both comprise a shell and tube heat exchanger, a spiral tube heat exchanger, a vertical combined feed exchanger, a plate bundle heat exchanger, or combinations thereof.

10. The process of claim 1 wherein the first process stream comprises a reboiler stream, a column feed stream, a reactor feed stream, or combinations thereof.

11. The process of claim 1 wherein the first process stream comprises a single phase or two phases.

12. An apparatus comprising:
a flash drum or a first column having an inlet and an outlet;
a first heat exchanger having a first inlet, a first outlet, a second inlet, and a second outlet, the first inlet being in downstream fluid communication with the outlet of the flash drum or the first column;
a fired heater, or an electric heater or furnace, or combinations thereof having an inlet and an outlet, the inlet of the fired heater, or the electric heater or furnace, or combinations thereof being in downstream fluid communication with the first outlet of the first heat exchanger;
a two phase separator having an inlet, a vapor outlet, and a liquid outlet, the inlet of the two phase separator being in downstream fluid communication with the outlet of the fired heater, or the electric heater or electric furnace, or combinations thereof;
a second heat exchanger having a first inlet, a first outlet, a second inlet, and a second outlet, the first inlet of the second heat exchanger being in downstream fluid communication with the vapor outlet of two phase separator, the second inlet of the second heat exchanger being in downstream fluid communication with a source of a process stream;
the second inlet of the first heat exchanger being in downstream fluid communication with the first outlet of the second heat exchanger;
a manifold having a first inlet, a second inlet, and an outlet, the first inlet of the manifold being in downstream fluid communication with the second outlet of the first heat exchanger, the second inlet of the manifold being in downstream fluid communication with the liquid outlet of the two phase separator; and
a second column having an inlet and an outlet, the inlet of the second column being in downstream fluid communication with the outlet of the manifold;
a first heater or heat source in thermal communication with a line between the vapor outlet of the two phase separator and the first inlet of the second heat exchanger;
a second heater or heat source in thermal communication with a line between the first outlet of second heat exchanger and the second inlet of the first heat exchanger.

13. The apparatus of claim 12 wherein the second inlet of the first heat exchanger is in selective downstream communication with the vapor outlet of the two phase separator.

14. The apparatus of claim 12 wherein the first heat exchanger or the second heat exchanger or both comprises a shell and tube heat exchanger, a spiral tube heat exchanger, a vertical combined feed exchanger, a plate bundle heat exchanger, or combinations thereof.

15. A process for preheating a feed stream to a second column, the feed stream comprising a stream from a flash drum or a stream from a first column, comprising:
heating the feed stream in a fired heater, or an electric heater or furnace, or combinations thereof forming a heated feed stream comprising a mixture of liquid and vapor;
separating the heated feed stream in a two phase separator into a vapor stream and a liquid stream;
heating the vapor stream forming a heated vapor stream;
heat exchanging the heated vapor stream with a first process stream in a first heat exchanger forming a cooled vapor stream and a heated process stream;
combining the cooled vapor stream from the heat exchanger and the liquid stream from the two phase separator forming a combined vapor and liquid stream; and
introducing the combined vapor and liquid stream to the second column.

16. The process of claim 15:
heating the cooled vapor stream forming a second heated vapor stream;
heat exchanging the second heated vapor stream in a second heat exchanger with a second process stream forming a second cooled vapor stream and a second heated process stream; and
wherein combining the cooled vapor stream from the heat exchanger and the liquid stream from the two phase separator comprises combining the second cooled vapor stream from the heat exchanger and the liquid stream from the two phase separator.

17. The process of claim 16 wherein the second process stream comprises a reboiler stream, a column feed stream, a reactor feed stream, or combinations thereof and wherein the second process stream comprises a single phase or two phases.

18. The process of claim 15:
wherein heating the vapor stream forming a heated vapor stream comprises heating the vapor stream using an electric heater or a second process stream; or
wherein heating the cooled vapor stream comprises heating the cooled vapor stream using an electric heater or a third process stream;
or both.

19. The process of claim 18 wherein the second process stream or the third process stream or both comprises a reboiler stream, a column feed stream, a reactor feedstream, or combinations thereof and wherein the second process stream or the third process stream comprises a single phase or two phases.

20. The process of claim 15 wherein the first heat exchanger or the second heat exchanger or both comprise a shell and tube heat exchanger, a spiral tube heat exchanger, a vertical combined feed exchanger, a plate bundle heat exchanger, or combinations thereof.
